(19) United States
(12) Patent Application Publication
(10) Pub. No.: US 2007/0298803 A1
(43) Pub. Date: Dec. 27, 2007

(54) RADIO NETWORK SYSTEM, RADIO BASE STATION AND HANDOVER CONTROL METHOD USED FOR THE SAME

(75) Inventors: HISASHI KAWABATA, Tokyo (JP); Kengo Oketani, Tokyo (JP); Yukio Haseba, Tokyo (JP); Daisuke Kondo, Tokyo (JP); Osami Nishimura, Tokyo (JP)

Correspondence Address: DICKSTEIN SHAPIRO LLP, 1177 AVENUE OF THE AMERICAS (6TH AVENUE), NEW YORK, NY, 10036-2714, US

(73) Assignee: NEC CORPORATION, Tokyo (JP)

(21) Appl. No.: 11/765,251

(22) Filed: Jun. 19, 2007

(30) Foreign Application Priority Data
Jun. 21, 2006 (JP) 2006/170817

(51) Int. Cl. H04Q 7/20

(52) U.S. Cl. 455/436

(57) ABSTRACT

The present invention provides a radio network system including a mobile station that leads in determining whether handover can be executed or not, wherein the handover is for switching a handover origin radio base station to a handover destination radio base station, wherein the handover destination radio base station reserves resources required for the handover based on a handover request from the mobile station and information on the mobile station required for the handover, and establishes a user plane path for transferring user information between itself and the handover origin node B.

### INCORPORATION BY REFERENCE

This application is based upon and claims the benefit of priority from Japanese patent application No. 2006-170817, filed on Jun. 21, 2006, the disclosure of which is incorporated herein its entirety by reference.

### BACKGROUND OF THE INVENTION

1. Field of the Invention

The present invention relates to a mobile communication system, a radio base station and a handover control method used in the same, and specifically to control of handover in a radio network system.

2. Description of the Related Art

In the present radio network system, RNC (radio network controller) 6 manages a plurality of nodes B (node-B: radio base station) 5-0 and 5-1, controlling handover between the nodes B 5-0 and 5-1 as shown in FIG. 9.

The processing of the RNC 6 has been complicated, however, contributing to complicate the entire radio network system. Thus, a configuration for eliminating the RNC 6 with the processing served by the RNC 6 being distributed among the nodes B 5-0 and 5-1 and the upper level gateway (not shown) (for example, see non-patent document “3GPP TSG-RAN WG3 Meeting #50, Sophia Antipolis, FRANCE, 10-12 Jan. 2006”), and a configuration for eliminating the RNC 6 with the distribution along with an RRM (radio resource management) server specialized in an RRC (radio resource control) function used for a c-plane (a control plane for signaling to transfer a control signal) processing between the node B 5-0 and 5-1 are reviewed.

For a system configuration of a radio network without an RNC 6, plural handover methods can be considered. Specifically as a method for simplifying the system configuration of the network among them, a system including a UE (user equipment: mobile station) 4-0 that leads in determining whether the handover can be executed or not is considered. A method by which the UE 4-0 leads in determining on handover execution is also proposed for the purpose of distributing the processing of the network and the nodes B 5-0 and 5-1.

The abovementioned conventional radio network system, however, performs an operation of transferring data from the origin of handover to the handover destination via an RNC to prevent data sent and received from being lost in the handover. Therefore, the method eliminating the RNC has a problem that data sent and received can be lost in handover, which lowers audio quality or increases incidence of resending a packet.

The object of the present invention is to provide a radio network system, a radio base station and a handover control method used for the same that can solve the abovementioned problem, and achieve smooth handover by reducing the incidence of data loss and redundancy of data in sending and receiving data at a radio base station when an UE leads in determining on execution of the handover.

### BRIEF SUMMARY OF THE INVENTION

The radio network system according to the present invention is a radio network system including a mobile station that leads in determining whether handover can be executed or not, wherein the handover is for switching a handover origin radio base station to a handover destination radio base station, wherein the handover destination radio base station reserves resources required for the handover based on a handover request from the mobile station and information on the mobile station required for the handover, and establishes a user plane path for transferring user information between itself and the handover origin node B.

### BRIEF DESCRIPTION OF THE DRAWINGS

FIG. 1 is a block diagram showing a configuration of a radio network system according to the first exemplary embodiment of the present invention;

FIG. 2 is a sequence chart showing an operation of a radio network system according to the first exemplary embodiment of the present invention;

FIG. 3 is a block diagram showing a configuration of a radio network system according to the second exemplary embodiment of the present invention;

FIG. 4 is a sequence chart showing operations of a radio network system according to the second exemplary embodiment of the present invention;

FIG. 5 is a sequence chart showing operations of a radio network system according to the third exemplary embodiment of the present invention;

FIG. 6 is a sequence chart showing operations of a radio network system according to the fourth exemplary embodiment of the present invention;

FIG. 7 is a flowchart showing discard of data at the handover destination node B 2-1 according to the fourth exemplary embodiment of the present invention;

FIG. 8 is a flowchart showing discard of data at the handover destination node B 2-1 according to the fourth exemplary embodiment of the present invention; and

FIG. 9 is a block diagram showing a configuration of a conventional radio network system.

### DETAILED DESCRIPTION OF THE EXEMPLARY EMBODIMENTS

Now, exemplary embodiments of the present invention will be described with reference to the drawings.

### Exemplary Embodiment 1

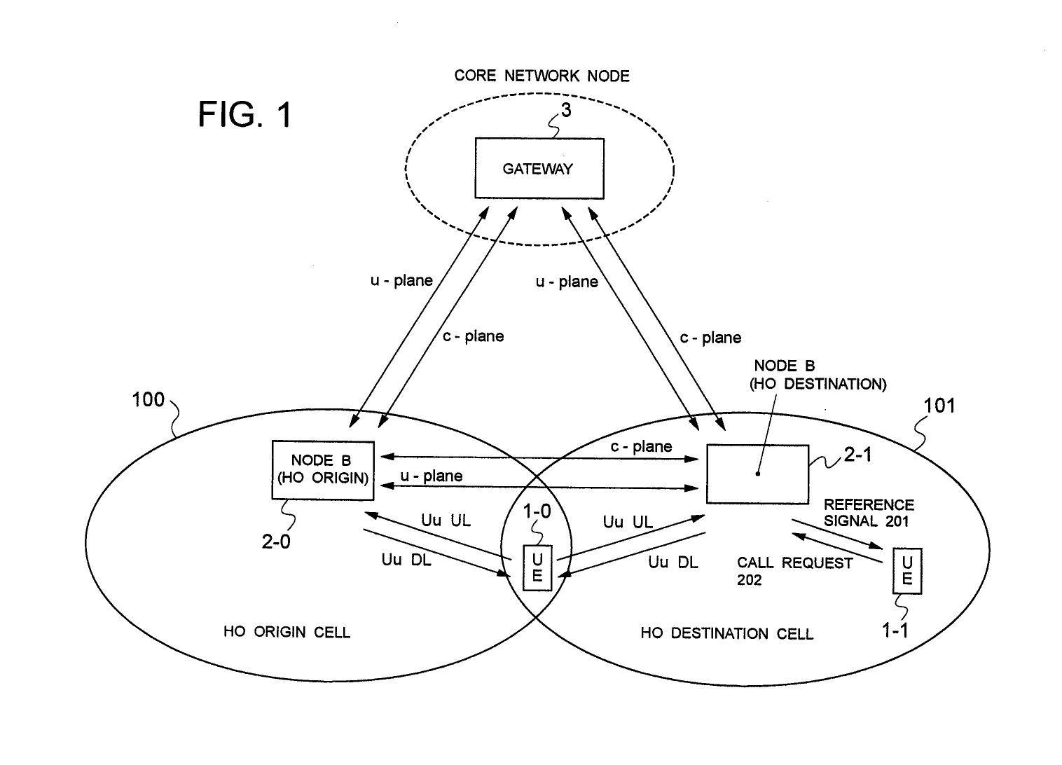

FIG. 1 is a block diagram showing a configuration of a radio network system according to the first exemplary embodiment of the present invention. In FIG. 1, the radio network system according to the first exemplary embodiment of the present invention includes UEs (user equipment: mobile station) 1-0 and 1-1, a handover origin node B (base station) 2-0, a handover destination node B 2-1, and a gateway 3. The radio network system has the RRC (radio resource control) function in the nodes B 2-0 and 2-1, with the handover origin node B 2-0 managing a handover origin cell 100 and the handover destination node B 2-1 managing a handover destination cell 101.

The UE 1-0 has functions of determining on transferring to the handover operation based on a quality of a signal or the like received from the handover origin node B 2-0 and sending a handover request to the handover origin node B 2-0. The functions will be described later.

The handover origin node B 2-0 has a function of sending a handover request to the handover destination node B 2-1 via a c-plane (a control plane for signaling to transfer a control signal) path between the nodes B 2-0 and 2-1 based on the handover request from the UE 1-0.

The handover origin node B 2-0 has functions of determining data required to be transferred to the handover destination B 2-1 among information required for the handover, specifically the sending and receiving data to and from the UE 1-0, and transferring the data to the handover destination node B 2-1 by using the u-plane path (a user plane for transferring user information) between the nodes B 2-0 and 2-1.

After the handover request and the data required to be transferred to the handover destination node B 2-1 have been transferred, the handover origin node B 2-0 executes the handover based on the node B switching instruction [RB (radio bearer) Reconfiguration] sent to the UE 1-0.

The communication starts between the UE 1-0 and the handover destination node B 2-1, and the u-plane path established between the handover origin node B 2-0 and the gateway 3 is switched to the handover destination node B 2-1 side. It is not necessary for the data path between the node B 2-0 and 2-1 to be formed with a dedicated circuit in particular and the data path can be formed with the IP (Internet protocol) network and the like.

The gateway 3 is a gateway station for connecting the nodes B 2-0 and 2-1 and the IP network or the public network. As the inner configuration of the gateway station is not included in the requirements of the present invention, they are omitted from the description.

Now, an operation of determining handover lead by the UE will be described. The UE 1-0 monitors each of reference signals from the handover origin node B 2-0 and the handover destination node B 2-1, and measures a receiving SIR (signal to interference power ratio). The UE 1-0 continues the monitoring until it becomes “the receiving SIR of the handover origin” <“the receiving SIR of the handover destination”. When it becomes “the receiving SIR of the handover origin” <“the receiving SIR of the handover destination”, the UE 1-0 starts monitoring resource information informed in a cycle of scheduling from the handover destination node B 2-1.

The resource information is generated based on the scheduling result performed at the handover destination node B 2-1 for informing whether the handover destination node B 2-1 can receive a handover call at each designated (scheduling) timing. The handover destination node B 2-1 determines whether it can receive a handover call or not based on the current usage of the resources and informs the UE 1-0 of the determination as the resource information. The simplest example of the resource information is one bit of information, with “1” indicating that the node B can receive the handover call and “0” indicating that the node B cannot receive the handover call.

Here, the resource information is generated based on the state of radio frequency resources between the node B and the UE, the physical state of channel resources at the node B, an instantaneous downlink total transmission power at the node B and the combinations thereof. As the node B in each cell can recognize all the kinds of information, the node B informs the resource information generated for the UE in the cell thereof and the node B in an adjacent cell. The UE 1-0 continues the monitoring of the resource information until the resource information indicates that “handover can be executed”. When it becomes “the receiving SIR of the handover origin” <“the receiving SIR of the handover destination” before the resource information indicates that “handover can be executed”, the UE 1-0 stops the monitoring of the resource information at the time.

When the state of the resource information indicates that handover can be executed, the UE 1-0 informs the handover destination node B 2-1 of a handover request. Informing method of the handover request may be a method for directly informing the handover destination node B of the handover request via a radio circuit by using a common channel, signaling or the like and a method for informing the handover destination node B of the handover request via the handover origin node B.

As mentioned above, the UE 1-0 compares the receiving SIR of the downlink reference signal from the handover origin node B 2-0 to which a radio circuit is currently connected and the receiving SIR of the downlink reference signal from the handover destination node B 2-1 to which a radio circuit is supposed to be connected by the handover. If the receiving SIR of the downlink reference signal from the handover destination node B 2-1 is bigger than the receiving SIR of the downlink reference signal from the handover origin node B 2-0, the UE 1-0 monitors the resource information informed from the handover destination node B 2-1. If it is confirmed that the resource information indicates that the handover can be executed, the UE 1-0 issues a handover request to the handover destination node B 2-1.

With the abovementioned processing, the handover destination node B 2-1 restricts the handover call. If a higher priority is set to a new call than the handover call, however, the UE 1-1 that performs a usual new calling issues a call request 202 instead of monitoring the resource information. When the handover destination node B 2-1 receives the handover request from the UE 1-0, it determines whether or not to accept the received handover request and sends the determination to the UE 1-0 as a handover response. Only when the received handover response indicates to permit the handover, the UE 1-0 executes handover to the handover destination node B 2-1.

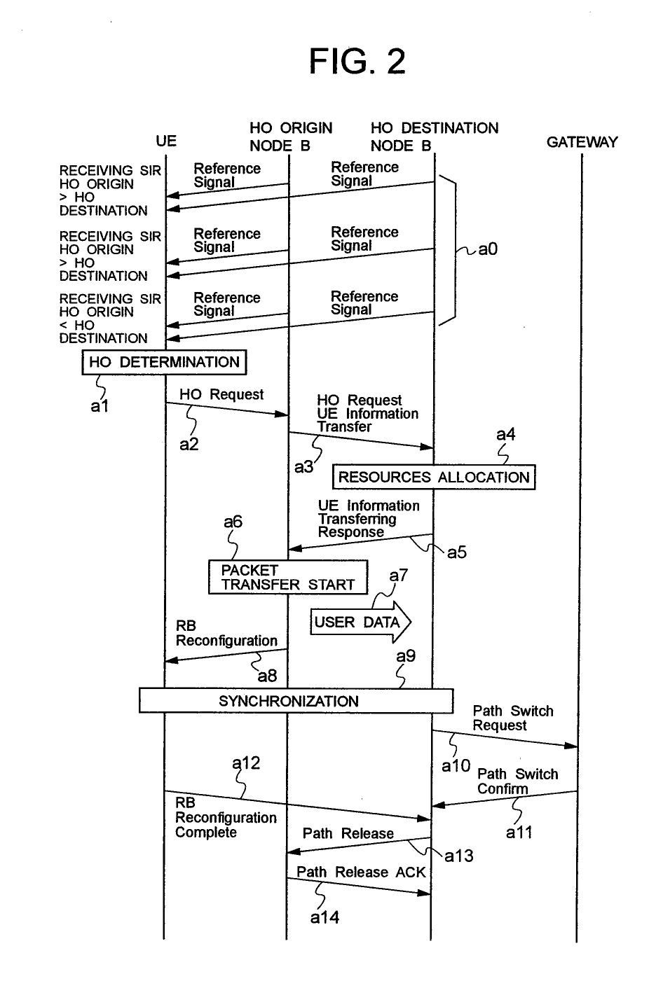

FIG. 2 is a sequence chart showing an operation of a radio network system according to the first exemplary embodiment of the present invention. Operations of the radio network system by the first exemplary embodiment of the present invention will be described with reference to FIG. 1 and FIG. 2. A case where the node B to which the UE 1-0 issues a handover request is the handover origin node B 2-0 will be described below.

The UE 1-0 receives signals from the handover origin node B 2-0 and the handover destination node B 2-1, compares the receiving SIRs of them and determines on transferring to handover operations (a0, a1 in FIG. 2). The handover determining operation in the UE 1-0 is mentioned above.

If the UE 1-0 determines to execute handover to the handover destination node B 2-1, it sends out a handover request to the handover origin node B 2-0 with designation of the handover destination node B 2-1 (a2 in FIG. 2). The handover origin node B 2-0 that received the handover request from the UE 1-0 sends the handover request to the handover destination node B 2-1 that is designated by the UE 1-0 (a3 in FIG. 2). Here, the handover origin node B 2-1 transfers UE information used by the UE 1-0 including bearer information, required quality of service (QoS) information and required memory information at the same time to reserve resources required by the handover destination node B 2-1 for communication with the UE 1-0.

When the handover destination node B 2-1 receives the signal from the handover origin node B 2-0, it executes resource allocation in the node B and reservation of the resources based on the information (a4 in FIG. 2). When the required resources have been reserved and preparation for the handover has been done, the handover destination node B 2-1 responds to the handover origin node B 2-0 to the UE information transfer (a5 in FIG. 2).

When the handover origin node B 2-1 receives the UE information transferring response, it establishes the u-plane path between itself and the handover destination node B 2-1 and starts transferring a user data packet to the handover destination node B 2-1 (a6, a7 in FIG. 2). Here, a packet that can be transferred for achieving handover without an instantaneous interruption is divided into three types:

(1) a packet that is sent by the handover origin node B 2-0 to the UE 1-0 but no Ack (acknowledgement) has been received from the UE 1-0;

(2) a packet that is received by the handover origin node B 2-0 from the upper level gateway 3 but has not been sent to the UE 1-0; and

(3) a packet that is received by the handover origin node B 2-0 from the UE 1-0 but no Ack has been sent to the UE 1-0.

When a packet of any of (1) to (3) has been transferred at the handover origin node B 2-0, the handover origin node B 2-0 sends an instruction to transfer to the handover destination node B 2-1 and the handover destination node B information required for the transferring to the UE 1-0 as the node B switching instruction [Radio link Bearer (RB) Reconfiguration] signal (a8 in FIG. 2).

The UE 1-0 receives the signal from the handover origin node B 2-0, starts communication with the handover destination node B 2-1 and becomes synchronized with the uplink and downlink lines (a9 in FIG. 2). The handover destination node B 2-1 issues the Path Switch Request signal to switch the u-plane path from the handover origin node B 2-0 to the handover destination node B 2-1 to the gateway 3 when the uplink synchronization has been established (a10 in FIG. 2).

When the gateway 3 receives the Path Switch Request signal, it switches the u-plane path to the handover destination node B 2-1 and returns a Path Switch Confirm signal to the handover destination node B 2-1 (all in FIG. 2).

When the downlink synchronization has been established, the UE 1-0 informs the handover destination node B 2-1 of the completion of the handover as the RB Reconfiguration Complete signal (a12 in FIG. 2). In response to the reception of the Path Switch Confirm signal and the RB Reconfiguration Complete signal, the handover destination node B 2-1 sends the Path Release signal to the handover origin node B 2-0 (a13 in FIG. 2).

In response to the Path Release signal, the handover origin node B 2-0 releases the resources of the uplink Uu-line and the u-plane path to the gateway 3 and returns the Path Release Ack signal indicating the release of the resources and the u-plane path to the handover destination node B 2-1 (a14 in FIG. 2). Here, a series of the handover sequence completed in the exemplary embodiment.

As such, the exemplary embodiment can achieve smooth handover by reducing the incidence of data loss and redundancy of data in sending or receiving data at the node B when the UE 1-0 leads in determining on execution of the handover.

### Exemplary Embodiment 2

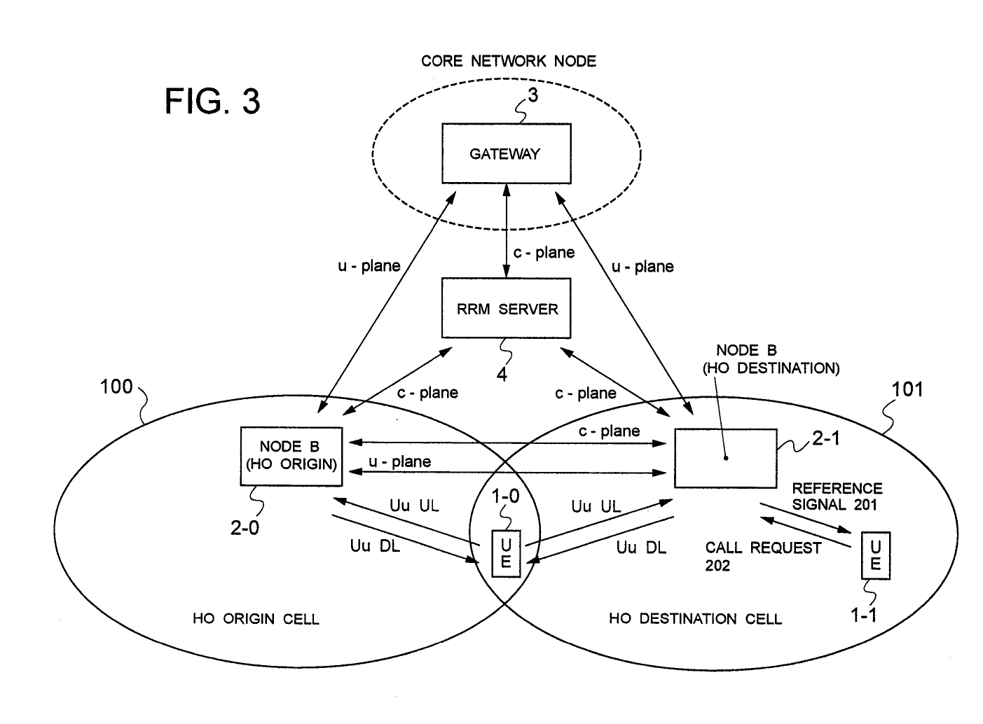

FIG. 3 is a block diagram showing a configuration of a radio network system according to the second exemplary embodiment of the present invention. The network system according to the second exemplary embodiment has the same configuration as that of the first exemplary embodiment of the present invention shown in FIG. 1 except that the radio network system according to the second exemplary embodiment of the present invention is provided with an RRM (radio resource management) server 4 that specially processes the RRC function of each node B in the first exemplary embodiment of the present invention in FIG. 1.

The RRM server 4 executes controlling and management over resource allocation of each node B (the handover origin node B 2-0 and the handover destination node B 2-1) and switching control over the u-plane path between the gateway 3 and each node B.

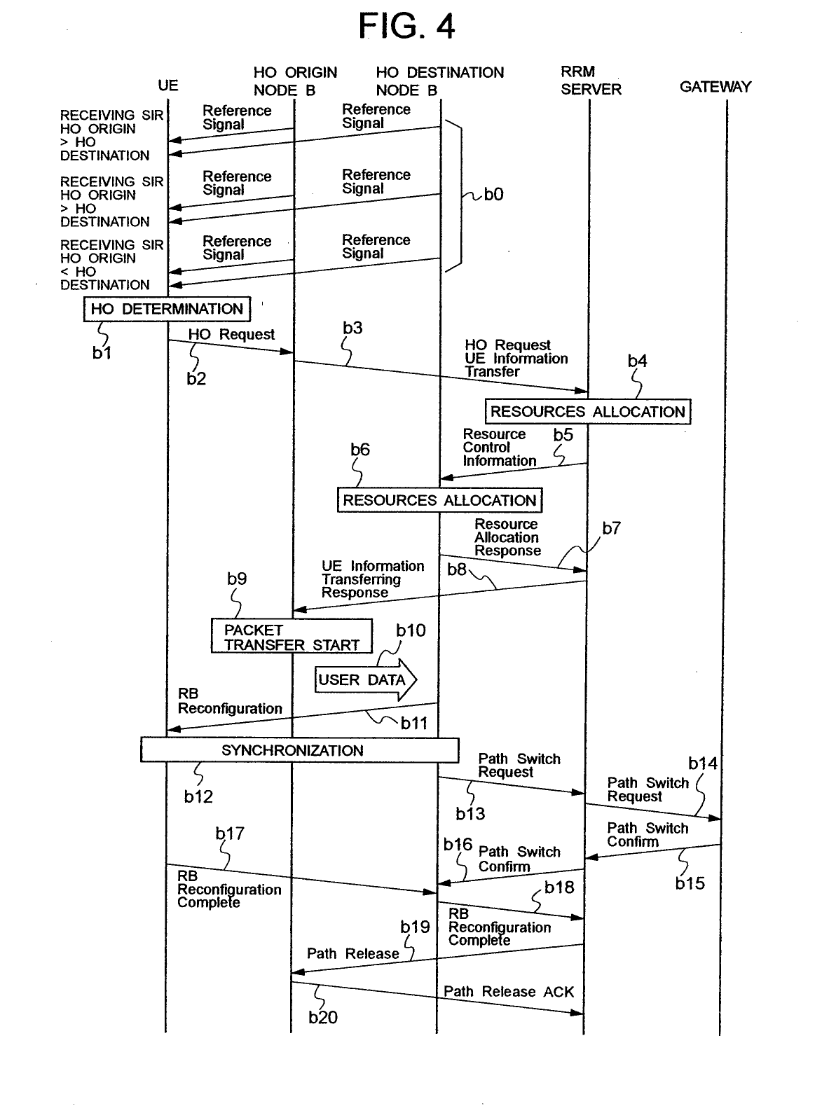

FIG. 4 is a sequence chart showing operations of a radio network system according to the second exemplary embodiment of the present invention. Operations of the radio network system according to the second exemplary embodiment of the present invention will be described with reference to FIG. 3 and FIG. 4. A case where the node B to which the UE 1-0 issues a handover request is the handover origin node B 2-0 will be described below.

The UE 1-0 receives signals from the handover origin node B 2-0 and the handover destination node B 2-1, compares the receiving SIRs of them and determines on transferring to handover operations (b0, b1 in FIG. 4). The handover determining operation in the UE 1-0 is mentioned above.

If the UE 1-0 determines to execute handover to the handover destination node B 2-1, it sends out a handover request to the handover origin node B 2-0 with designation of the handover destination node B 2-1 (b2 in FIG. 4). The handover origin node B 2-0 that received the handover request from the UE 1-0 sends the handover request from the UE 1-0 to the RRM server 4 (b3 in FIG. 3). Here, the handover origin node B 2-0 transfers UE information used by the UE 1-0 including bearer information, required quality of service (QoS) information and required memory information at the same time to reserve resources required by the handover destination node B 2-1 for communication with the UE 1-0 to the RRM server 4.

When the RRM server 4 receives the signal from the handover origin node B 2-0, it sends resource control information to the handover destination node B 2-1 to make resource allocation in the handover destination node B 2-1 and reservation of the resources based on the information (b4, b5 in FIG. 4). When the handover destination node B 2-1 receives the resource control information from the RRM server 4, it executes the resource allocation in the node B and the resource reservation based on the resource control information (b6 in FIG. 4).

When the required resources have been reserved and preparation for the handover has been done, the handover destination node B 2-1 responds to the RRM server 4 about the resources allocation (b7 in FIG. 4). When the RRM server 4 receives the response indicating the resource allocation, it responds to the handover origin node B 2-0 to the UE information transfer (b8 in FIG. 4).

When the handover origin node B 2-1 receives the UE information transferring response, it establishes the u-plane path between itself and the handover destination node B 2-1 and starts transferring a user data packet to the handover destination node B 2-1 (b9, b10 in FIG. 4). Here, a packet that can be transferred for achieving handover without an instantaneous interruption is any of the packets mentioned above (1) to (3).

When a packet of any of (1) to (3) has been transferred at the handover origin node B 2-0, the handover destination node B 2-1 sends an instruction to transfer to the handover destination node B 2-1 and the handover destination node B information required for the transferring to the UE 1-0 as the node B switching instruction [RB Reconfiguration] signal (b11 in FIG. 4).

The UE 1-0 receives the signal from the handover destination node B 2-1, starts communication with the handover destination node B 2-1 and becomes synchronized with the uplink and downlink lines (b12 in FIG. 4). The handover destination node B 2-1 issues the Path Switch Request signal to switch the u-plane path from the handover origin node B 2-0 to the handover destination node B 2-1 to the gateway 3 via the RRM server 4 when the uplink synchronization has been established (b13, b14 in FIG. 4).

When the gateway 3 receives the Path Switch Request signal, it switches the u-plane path to the handover destination node B 2-1 and returns a Path Switch Confirm signal to the handover destination node B 2-1 via the RRM server 4 (b15, b16 in FIG. 4).

When the downlink synchronization has been established, the UE 1-0 informs the RRM server 4 of the completion of the handover as the RB Reconfiguration Complete signal via the handover destination node B 2-1 (b17, b18 in FIG. 4). In response to the reception of the Path Switch Confirm signal and the RB Reconfiguration Complete signal, the RRM server 4 sends the Path Release signal to the handover origin node B 2-0 (b19 in FIG. 4).

In response to the Path Release signal, the handover origin node B 2-0 releases the resources of the uplink Uu-line and the u-plane path to the gateway 3 and returns the Path Release Ack signal indicating the release of the resources and the u-plane path to the RRM server 4 (b20 in FIG. 4). Here, a series of the handover sequence completed in the exemplary embodiment.

As such, the exemplary embodiment can achieve smooth handover by reducing the incidence of data loss and redundancy of data in sending or receiving data at the node B when the UE 1-0 leads in determining on execution of the handover as in the first exemplary embodiment of the present invention.

### Exemplary Embodiment 3]

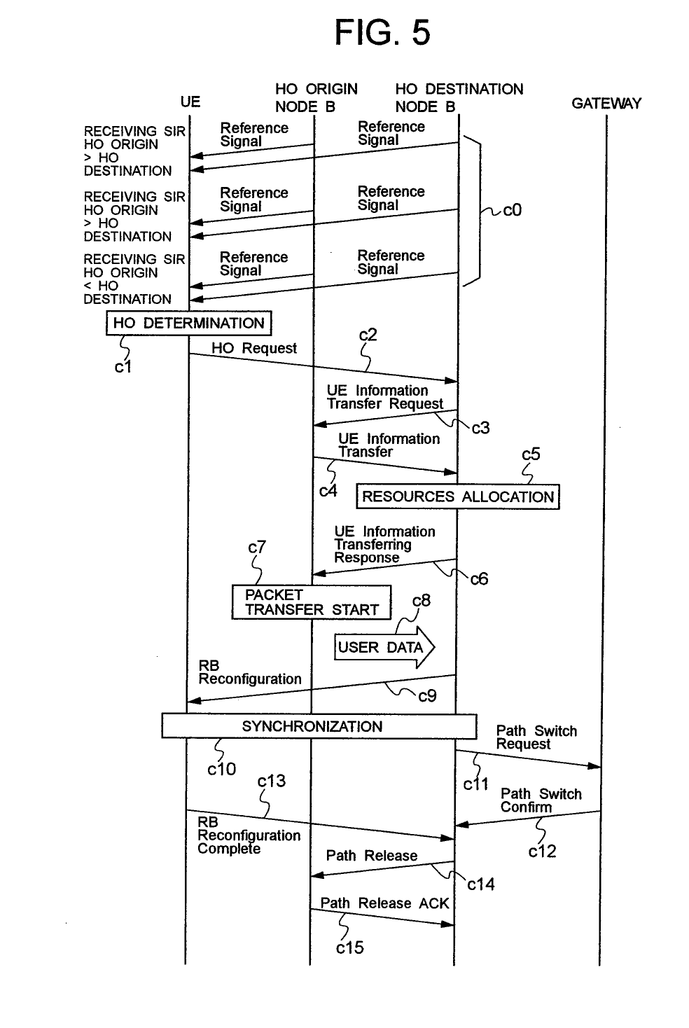

FIG. 5 is a sequence chart showing operations of a radio network system according to the third exemplary embodiment of the present invention. The radio network system according to the third exemplary embodiment of the present invention has the same configuration as that of the first exemplary embodiment of the present invention shown in FIG. 1. Operations of the radio network system according to the third exemplary embodiment of the present invention will be described with reference to FIG. 1 and FIG. 5. A case where the node B to which the UE 1-0 issues a handover request is the handover origin node B 2-0 and the handover request from the UE 1-0 is directly sent to the handover destination node B 2-1 will be described below.

The UE 1-0 receives signals from the handover origin node B 2-0 and the handover destination node B 2-1, compares the receiving SIRs of them and determines on transferring to handover operations (c0, c1 in FIG. 5). The handover determining operation in the UE 1-0 is mentioned above.

If the UE 1-0 determines to execute handover to the handover destination node B 2-1, it sends out a handover request to the handover destination node B 2-1 with designation of the handover destination node B 2-1 (c2 in FIG. 5). The handover destination node B 2-1 that received the handover request from the UE 1-0 sends a request to transfer UE information used by the UE 1-0 including bearer information, required quality of service (QoS) information and required memory information to reserve resources required by the handover destination node B 2-1 for communication with the UE 1-0 to the handover origin node B 2-0 (c3 in FIG. 5). In response to reception of the transferring request, the handover origin node B 2-0 transfers UE information used by the UE 1-0 including bearer information, required quality of service (QoS) information and required memory information to the handover destination node B 2-1 (c4 in FIG. 5).

When the handover origin node B 2-1 receives the information from the handover origin node B 2-0, it executes the resource allocation in the node B and the resource reservation based on the information (c5 in FIG. 5). When the required resources have been reserved and preparation for the handover has been done, the handover destination node B 2-1 responds to the handover origin node B 2-0 about the UE information transfer (c6 in FIG. 5).

When the handover origin node B 2-1 receives the UE information transferring response, it establishes the u-plane path between itself and the handover destination node B 2-1 and starts transferring a user data packet to the handover destination node B 2-1 (c7, c8 in FIG. 5). Here, a packet that can be transferred for achieving handover without an instantaneous interruption is any of the packets mentioned above (1) to (3).

When a packet of any of (1) to (3) has been transferred from the handover origin node B 2-0, the handover destination node B 2-1 sends an instruction to transfer to the handover destination node B 2-1 and the handover destination node B information required for the transferring to the UE 1-0 as the node B switching instruction [Radio link Bearer (RB) Reconfiguration] signal (c9 in FIG. 5).

The UE 1-0 receives the signal from the handover destination node B 2-1, starts communication with the handover destination node B 2-1 and becomes synchronized with the uplink and downlink lines (c10 in FIG. 5). The handover destination node B 2-1 issues the Path Switch Request signal to switch the u-plane path from the handover origin node B 2-0 to the handover destination node B 2-1 to the gateway 3 when the uplink synchronization has been established (c11 in FIG. 5).

When the gateway 3 receives the Path Switch Request signal, it switches the u-plane path to the handover destination node B 2-1 and returns a Path Switch Confirm signal to the handover destination node B 2-1 (c12 in FIG. 5).

When the downlink synchronization has been established, the UE 1-0 informs the handover destination node B 2-1 of the completion of the handover as the RB Reconfiguration Complete signal (c13 in FIG. 5). In response to the reception of the Path Switch Confirm signal and the RB Reconfiguration Complete signal, the handover destination node B 2-1 sends the Path Release signal to the handover origin node B 2-0 (c14 in FIG. 5).

In response to the Path Release signal, the handover origin node B 2-0 releases the resources of the uplink Uu-line and the u-plane path to the gateway 3 and returns the Path Release Ack signal indicating the release of the resources and the u-plane path to the handover destination node B 2-1 (c15 in FIG. 5). Here, a series of the handover sequence has completed in the exemplary embodiment.

If the UE 1-0 previously keeps a parameter required for communication with the handover destination node B 2-1 from notified information or the like, the UE 1-0 can directly send a handover request to the handover destination node B 2-1. In such a case, the handover destination node B 2-1 controls over the handover until the RB Reconfiguration is reached, as mentioned above.

As such, the exemplary embodiment can achieve smooth handover by reducing the incidence of data loss and redundancy of data in sending or receiving data at the node B when the UE 1-0 leads in determining on execution of the handover.

### Exemplary Embodiment 4

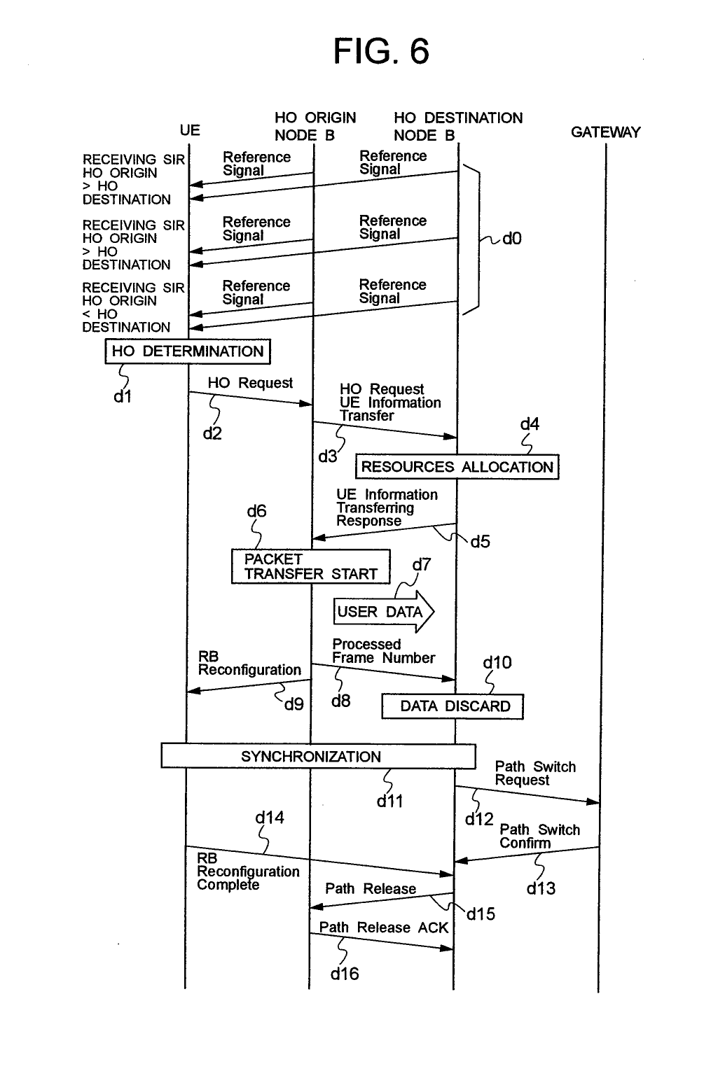

FIG. 6 is a sequence chart showing operations of a radio network system according to the fourth exemplary embodiment of the present invention. The radio network system according to the fourth exemplary embodiment of the present invention has the same configuration as that of the first exemplary embodiment of the present invention shown in FIG. 1. Operations of the radio network system according to the fourth exemplary embodiment of the present invention will be described with reference to FIG. 1 and FIG. 6. A case where the node B to which the UE 1-0 issues a handover request is the handover origin node B 2-0 and the handover request from the UE 1-0 is directly sent to the handover destination node B 2-1 will be described below.

In the first to the third exemplary embodiments, a case where “DL (download) sent data before Ack is received from the UE”, “DL sent data that has not be sent to the UE” and “UL (upload) data for which Ack has not sent to the UE” are transferred in transferring between nodes B is exemplified.

A processing time required for setting transfer and a transferring time according to the amount of data and the transfer rate are required in executing data transfer. If the handover origin node B 2-0 can keep communication with the UE 1-0 during the processing time and the transferring time, a period of interruption in the communication can be reduced so that smoother handover can be achieved.

This also indicates that the data that has been started being transferred can be redundant data that need not be transferred until the transfer ends. The exemplary embodiment may have a system for discarding redundant transfer data to reduce the redundancy and processing load to improve processing efficiency. The system is shown in the exemplary embodiment.

The UE 1-0 receives signals from the handover origin node B 2-0 and the handover destination node B 2-1, compares the receiving SIRs of them and determines on transferring to handover operations (d0, d1 in FIG. 6). The handover determining operation in the UE 1-0 is mentioned above.

If the UE 1-0 determines to execute handover to the handover destination node B 2-1, it sends out a handover request to the handover origin node B 2-0 with designation of the handover destination node B 2-1 (d2 in FIG. 6). The handover origin node B 2-0 that received the handover request from the UE 1-0 sends a handover request to the handover destination node B 2-1 designated by the UE 1-0 (d3 in FIG. 6). Here, the handover origin node B 2-0 transfers UE information used by the UE 1-0 including bearer information, required quality of service (QoS) information and required memory information at the same time to reserve resources required by the handover destination node B 2-1 for communication with the UE 1-0.

When the handover destination node B 2-1 receives the signal from the handover origin node B 2-0, it executes the resource allocation in the node B and the resource reservation based on the information (d4 in FIG. 6). When the required resources have been reserved and preparation for the handover has been done, the handover destination node B 2-1 responds to the handover origin node B 2-0 about the UE information transfer (d5 in FIG. 6).

When the handover origin node B 2-0 receives the UE information transferring response, it establishes the u-plane path between itself and the handover destination node B 2-1 and starts transferring a user data packet to the handover destination node B 2-1 (d6, d7 in FIG. 6). Here, a packet that can be transferred for achieving handover without an instantaneous interruption is any of the packets mentioned above (1) to (3).

When a packet of (1) to (3) has been transferred at the handover origin node B 2-0, the handover origin node B 2-0 sends a processed frame number to the handover destination node B 2-1 (d8 in FIG. 6) and sends an instruction to transfer to the handover destination node B 2-1 and the handover destination node B information required for the transfer to the UE 1-0 as the node B switching instruction [Radio link Bearer (RB) Reconfiguration] signal (d9 in FIG. 6). The handover destination node B 2-1 discards the processed data based on the processed frame number from the handover origin node B 2-0 (d10 in FIG. 6).

The UE 1-0 receives the signal from the handover origin node B 2-0, starts communication with the handover destination node B 2-1 and becomes synchronized with the uplink and downlink lines (d11 in FIG. 6). The handover destination node B 2-1 issues the Path Switch Request signal to switch the u-plane path from the handover origin node B 2-0 to the handover destination node B 2-1 to the gateway 3 when the uplink synchronization has been established (d12 in FIG. 6).

When the gateway 3 receives the Path Switch Request signal, it switches the u-plane path to the handover destination node B 2-1 and returns a Path Switch Confirm signal to the handover destination node B 2-1 (d13 in FIG. 6).

When the downlink synchronization has been established, the UE 1-0 informs the handover destination node B 2-1 of the completion of the handover as the RB Reconfiguration Complete signal (d14 in FIG. 6). In response to the reception of the Path Switch Confirm signal and the RB Reconfiguration Complete signal, the handover destination node B 2-1 sends the Path Release signal to the handover origin node B 2-0 (d15 in FIG. 6).

In response to the Path Release signal, the handover origin node B 2-0 releases the resources of the uplink Uu-line and the u-plane path to the gateway 3 and returns the Path Release Ack signal indicating the release of the resources and the u-plane path to the handover destination node B 2-1 (d16 in FIG. 6). Here, a series of the handover sequence has completed in the exemplary embodiment.

When the transfer has completed at the handover origin node B 2-0 as mentioned above, the exemplary embodiment can discard the processed data at the handover destination node B 2-1 by sending “the received frame number N_{RL} for which Ack was returned to the UE last” and “the sent frame number N_{TL} that was sent to the UE last” to the handover destination node B 2-1.

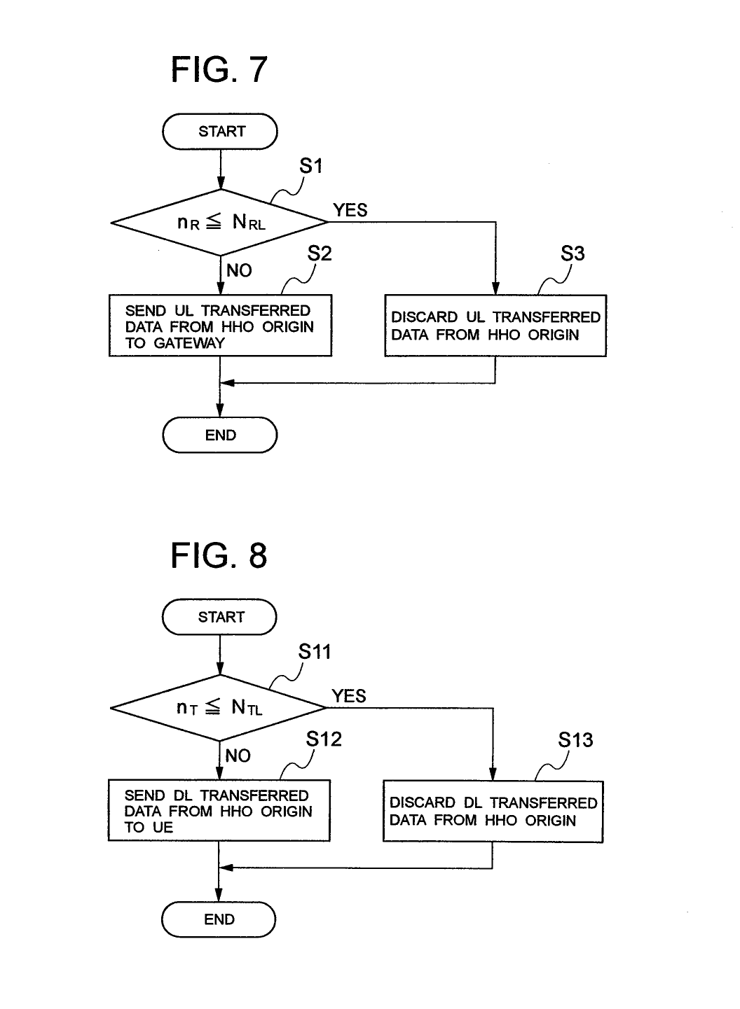

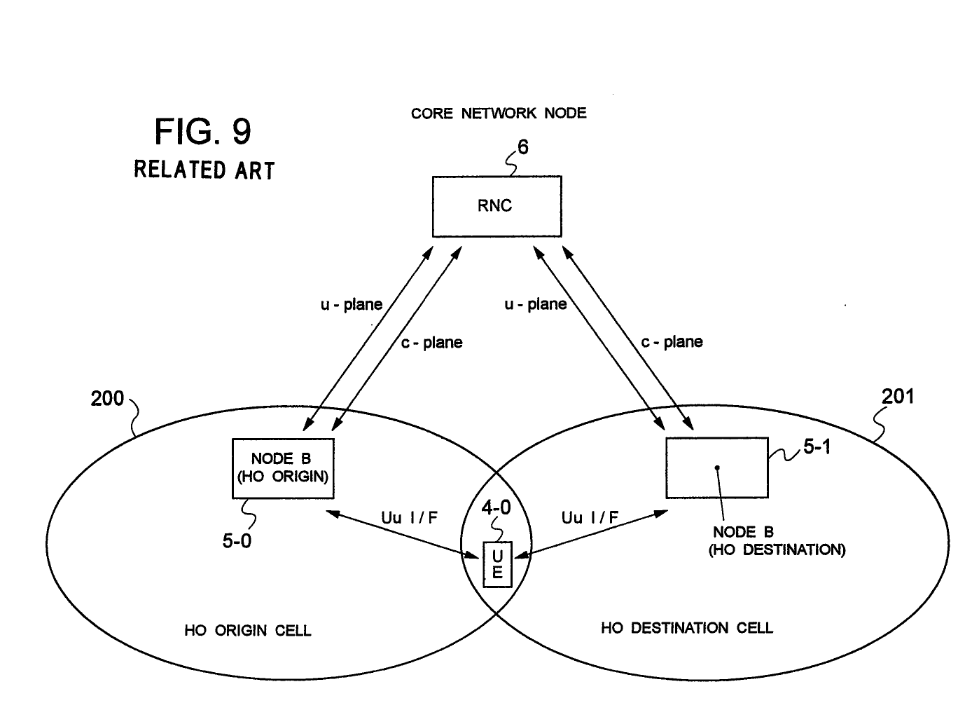

Each of FIG. 7 and FIG. 8 is a flowchart showing discard of data at the handover destination node B 2-1 according to the fourth exemplary embodiment of the present invention. Discard of data at the handover destination node B 2-1 according to the fourth exemplary embodiment of the present invention will be described with reference to FIG. 7 and FIG. 8.

When the handover destination node B 2-1 receives the processed frame number from the handover origin node B 2-0, it compares the u-plane data frame number n_{R} that is transferred from the handover origin node B 2-0 with the received frame number N_{RL} for which Ack was returned to the UE 1-0 last and determines whether the u-plane data frame number n_{R} is smaller than the received frame number N_{RL} (n_{R}≦N_{RL}) or not (step S1 in FIG. 7).

If the u-plane data frame number n_{R} is bigger than the received frame number N_{RL}, the handover destination node B 2-1 sends UL transferred data from the handover origin node B 2-0 to the gateway 3 (step S2 in FIG. 7). If the u-plane data frame number n_{R} is smaller than the received frame number N_{RL}, the handover destination node B 2-1 discards the UL transferred data from the handover origin node B 2-0 (step S3 in FIG. 7).

When the handover destination node B 2-1 receives the processed frame number from the handover origin node B 2-0, it compares the u-plane data frame number n_{T} that is transferred from the handover origin node B 2-0 with the sent frame number N_{TL} that was sent to the UE 1-0 last and determines whether the u-plane data frame number n_{T} is smaller than the sent frame number N_{TL} (n_{T}≦N_{TL}) or not (step S11 in FIG. 8).

If the u-plane data frame number n_{T} is bigger than the sent frame number N_{TL}, the handover destination node B 2-1 sends DL transferred data from the handover origin node B 2-0 to the UE 1-0 (step S12 in FIG. 8). If the u-plane data frame number n_{T} is smaller than the sent frame number N_{TL}, the handover destination node B 2-1 discards the DL transferred data from the handover origin node B 2-0 (step S13 in FIG. 8).

In the exemplary embodiment, the handover destination node B 2-1 compares the u-plane data frame numbers at both of the UL and DL (n_{R}, n_{T}) that are transferred from the handover origin node B 2-0 with the received frame number N_{RL} and the sent frame number N_{TL} to determine the data frame that has been processed at the handover origin node B 2-0, and discard a redundant frame without sending it to the UE 1-0 or the gateway 3 as mentioned above. Thus, the exemplary embodiment can achieve smooth handover by reducing the incidence of data loss and redundancy of data in sending or receiving data at the node B when the UE 1-0 leads in determining on execution of the handover.

### Exemplary Embodiment 5

The exemplary embodiment 5 according to the present invention is the radio base station performing a processing operation described in the radio network system.

### Exemplary Embodiment 6

The exemplary embodiment 6 according to the present invention is a handover control method used in a radio network system including a mobile station that leads in determining whether handover can be executed or not, wherein the handover is for switching a handover origin radio base station to a handover destination radio base station, wherein the handover destination radio base station reserves resources required for the handover based on a handover request from the mobile station and information on the mobile station required for the handover, and establishes a user plane path for transferring user information between itself and the handover origin node B.

### Exemplary Embodiment 7

The exemplary embodiment 7 according to the present invention is the radio network system that eliminates an RNC (radio network controller) from the system, controls handover by mainly using a UE (user equipment: mobile station) in executing the handover in the system where a node used in controlling a call is simplified to realize the handover.

### Exemplary Embodiment 8

The exemplary embodiment 8 according to the present invention is the radio network system including a UE that leads in determining whether handover can be executed or not, wherein the processing of the network and node B (radio base station) can be distributed. A method for determining on execution of handover lead by the UE is performed as below.

### Exemplary Embodiment 9

The exemplary embodiment 9 according to the present invention is the UE which monitors each of reference signals from the handover origin node B and the handover destination node B, measures a receiving SIR (signal to interference power ratio) It continues the monitoring until it becomes “the receiving SIR of the handover origin”<“the receiving SIR of the handover destination”. When it becomes “the receiving SIR of the handover origin”<“the receiving SIR of the handover destination”, it starts monitoring resource information informed of in a cycle of scheduling from the handover destination node B.

### Exemplary Embodiment 10

The exemplary embodiment 10 according to the present invention is the resource information which is generated based on the scheduling result performed at the handover destination node B for informing whether the handover destination node B can receive a handover call at each designated (scheduling) timing. The handover destination node B determines whether it can receive a handover call or not based on the current usage of the resources and informs the UE of the determination as the resource information. The simplest example of the resource information is one bit of information, with “1” indicating that the node B can receive the handover call and “0” indicating that the node B cannot receive the handover call.

### Exemplary Embodiment 11

The exemplary embodiment 11 according to the present invention is the resource information which is generated based on the state of radio frequency resources between the node B and the UE, the physical state of channel resources at the node B, an instantaneous downlink total transmission power at the node B and the combinations thereof. As the node B in each cell can recognize all the kinds of information, the node B informs the resource information generated for the UE in the cell thereof and the node B in an adjacent cell. The UE continues the monitoring of the resource information until the resource information indicates that “handover can be executed”. When it becomes “the receiving SIR of the handover origin” <“the receiving SIR of the handover destination” before the resource information indicates that “handover can be executed”, the UE stops the monitoring of the resource information.

### Exemplary Embodiment 12

The exemplary embodiment 12 according to the present invention is the UE which informs the handover destination node B of a handover request, when the state of the handover information indicates that handover can be executed.

### Exemplary Embodiment 13

The exemplary embodiment 13 according to the present invention is the informing method of the handover request which may be a method for directly informing the handover destination node B of the handover request via a radio circuit by using a common channel, signaling or the like and a method for informing the handover destination node B of the handover request via the handover origin node B.

### Exemplary Embodiment 14

The exemplary embodiment 14 according to the present invention is the radio network system including a UE that leads in determining on handover as mentioned above, wherein a procedure for re-establishing the u-plane (user plane for transferring user information) path between nodes B is provided for enabling u-plane data to be smoothly handed over without passing through the RNC.

### Exemplary Embodiment 15

The exemplary embodiment 15 according to the present invention is the radio network system which includes a UE, a handover origin node B, a handover destination node B and a gateway, with a function of the RRC (radio resource control) provided for the node B.

### Exemplary Embodiment 16

The exemplary embodiment 16 according to the present invention is the UE which monitors the downlink quality of each node B for deciding to send out a handover request. The handover origin node B receives the handover request sent out from the UE, and sends the handover request and information on the UE required for the handover to the handover destination node B via the c-plane (a control plane for signaling to transfer a control signal) path between nodes B.

### Exemplary Embodiment 17

The exemplary embodiment 17 according to the present invention is the handover destination node B which reserves resources required for the handover based on the handover request. The handover origin node B and the handover destination node B establish a u-plane path between them for transferring user data from the handover origin node B to the handover destination node B. The gateway connects the nodes B under itself and an IP (Internet protocol) network or a public network.

### Exemplary Embodiment 18

The exemplary embodiment 18 according to the present invention is the radio network system which switches the node B, with which the UE communicates, based on a node B switching instruction [RB (radio link bearer) Reconfiguration] sent from the handover origin node B after the abovementioned handover request and the information of the UE has transferred, while switching the u-plane path to the gateway to the handover destination node B.

### Exemplary Embodiment 19

The exemplary embodiment 19 according to the present invention is the radio network system which can reduce the incidence of data loss and redundancy of data in sending and receiving data at a base station to achieve smooth handover when an UE leads in determining on execution of the handover.

### Exemplary Embodiment 20

The exemplary embodiment 20 according to the present invention is the invention which has an advantage to reduce the incidence of data loss and redundancy of data in sending and receiving data at a base station to achieve smooth handover when an UE leads in determining on execution of the handover with the configuration and operation mentioned above.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. A radio network system comprising a mobile station that leads in determining whether handover can be executed or not, wherein the handover is for switching a handover origin radio base station to a handover destination radio base station, wherein
the handover destination radio base station reserves resources required for said handover based on a handover request from said mobile station and information on said mobile station required for said handover, and establishes a user plane path for transferring user information between itself and said handover origin node B.

2. The radio network system according to claim 1, wherein
said mobile station sends said handover request to said handover origin radio base station, and
said handover origin radio base station transfers the handover request and information on said mobile station required for the handover to said handover destination radio base station when it receives said handover request.

3. The radio network system according to claim 1, wherein
said mobile station sends said handover request to said handover destination radio base station, and
said handover destination radio base station requests information on said mobile station required for the handover to said handover origin radio base station and obtains the information when it receives said handover request.

4. The radio network system according to claim 1, wherein
said mobile station sends said handover request to an RRM (Radio Resource Management) server that specially processes the resources control in said radio base station; and
said RRM server requests information on said mobile station required for the handover to said handover origin radio base station and obtains the information when it receives said handover request, and transfers the obtained information on the mobile station to said handover destination radio base station with said handover request.

5. The radio network system according to claim 1, wherein
after said handover request and information on said mobile station have been transferred, the destination of communication by said mobile station is switched to said handover destination radio base station based on a switching instruction issued by said handover origin radio base station, and a user plane path with a gateway that connects at least the IP (internet protocol) network and a public network with a radio base station under said gateway is switched toward said handover destination radio base station.

6. The radio network system according to claim 1, wherein
said mobile station monitors downlink quality of said radio base station and decides to send out said handover request based on the monitoring result.

7. A radio base station according to claim 1.

8. A handover control method used in a radio network system comprising a mobile station that leads in determining whether handover can be executed or not, wherein the handover is for switching a handover origin radio base station to a handover destination radio base station, wherein
said handover destination radio base station reserves resources required for said handover based on a handover request from said mobile station and information on said mobile station required for said handover, and establishes a user plane path for transferring user information between itself and said handover origin node B.

9. The handover control method according to claim 8, wherein
said mobile station sends said handover request to said handover origin radio base station, and
said handover origin radio base station transfers the handover request and information on said mobile station required for the handover to said handover destination radio base station when it receives said handover request.

10. The handover control method according to claim 8, wherein
said mobile station sends said handover request to said handover destination radio base station, and
said handover destination radio base station requests information on said mobile station required for the handover from said handover origin radio base station and obtains the information when it receives said handover request.

11. The handover control method according to claim 8, wherein
said mobile station sends said handover request to an RRM (Radio Resource Management) server that specially processes the resources information in said radio base station; and
said RRM server requests information on said mobile station required for the handover from said handover origin radio base station and obtains the information when it receives said handover request, and transfers the obtained information on the mobile station to said handover destination radio base station with said handover request.

12. The handover control method according to claim 8, wherein
after said handover request and information on said mobile station have been transferred, the destination of communication by said mobile station is switched to said handover destination radio base station based on a switching instruction issued by said handover origin radio base station, and a user plane path with a gateway that connects at least the IP (internet protocol) network and a public network with a radio base station under said gateway is switched toward said handover destination radio base station.

13. The handover control method according to claim 8, wherein
said mobile station monitors downlink quality of said radio base station and decides to send out said handover request based on the monitoring result.

14. A radio network system comprising a mobile station that leads in determining whether handover can be executed or not, wherein the handover is for switching a handover origin radio base station to a handover destination radio base station, wherein
the handover destination radio base station comprises means of reserving resources required for said handover based on a handover request from said mobile station and information on said mobile station required for said handover, and establishing a user plane path for transferring user information between itself and said handover origin node B.
